(19) United States
(12) Patent Application Publication
(10) Pub. No.: US 2024/0289073 A1
(43) Pub. Date: Aug. 29, 2024

(54) IMAGE PROCESSING CONTROL SYSTEM, CONTROL APPARATUS, AND IMAGE PROCESSING APPARATUS

(71) Applicant: SEIKO EPSON CORPORATION, Tokyo (JP)

(72) Inventor: Shusuke KIBUNE, Matsumoto-shi (JP)

(21) Appl. No.: 18/587,473

(22) Filed: Feb. 26, 2024

(30) Foreign Application Priority Data
Feb. 27, 2023 (JP) 2023-028139
Mar. 24, 2023 (JP) 2023-047492

(51) Int. Cl. G06F 3/12

(52) U.S. Cl. CPC G06F 3/124; G06F 3/1203; G06F 3/1259

(57) ABSTRACT

An image processing control system includes a plurality of image processing units configured to execute an image process for performing printing in a printing apparatus and a control unit configured to cause the plurality of image processing units to execute the image process. The control unit outputs control information to a first image processing unit, the control information including information indicating input data to be processed and the image processing unit that performs a next process on processed output data. The first image processing unit executes a first image process on the input data based on the control information and outputs the output data to the image processing unit that performs a next process.

The present application is based on, and claims priority from JP Application Serial Number 2023-047492, filed Mar. 24, 2023, and JP Application Serial Number 2023-028139, filed Feb. 27, 2023, the disclosure of which is hereby incorporated by reference herein in its entirety.

### BACKGROUND

### 1. Technical Field

The present disclosure relates to an image processing control system, a control apparatus, and an image processing apparatus.

### 2. Related Art

In the related art, a technique has been known that speeds up an image process for printing. For example, JP-A-2007-310450 discloses a technique in which a print manager allocates a job to a plurality of raster image processors (RIP) according to job contents to perform parallel processes.

JP-A-2007-310450 is an example of the related art.

In the related art, a manager allocates a job to a PC and causes the PC to execute RIP processes simultaneously in parallel. Then, the print data subjected to the RIP process is returned to the manager, and the manager arranges the print data for each client, arranges the print data in the order of pages, and outputs the print data to a printing apparatus. Accordingly, a management load for the manager is large.

### SUMMARY

In order to solve the above problems, an image processing control system is provided including a plurality of image processing units configured to execute an image process for performing printing in a printing apparatus and a control unit configured to cause the plurality of image processing units to execute the image process. The control unit outputs control information to a first image processing unit, the control information including information indicating input data to be processed and the image processing unit that performs a next process on processed output data. The first image processing unit executes a first image process on the input data based on the control information and outputs the output data to the image processing unit that performs a next process.

In order to solve the above problems, a control apparatus for causing a plurality of image processing units, which are configured to execute an image process for performing printing in a printing apparatus, to execute the image process is provided. The control apparatus outputs control information to the image processing unit, the control information including information indicating input data to be processed and the image processing unit that is to perform a next process on processed output data.

In order to solve the above problems, an image processing apparatus for executing any of a plurality of image processes for performing printing in a printing apparatus is provided. The image processing apparatus executes the image process on input data to be processed, based on control information including information indicating the input data and an image processing apparatus that executes a next process on processed output data, and outputs the output data to the image processing apparatus that executes a next process.

In order to solve the above problems, an image processing control method for causing a plurality of image processing units, which are configured to execute an image process for performing printing in a printing apparatus, to execute the image process is provided, the method including: outputting control information to a first image processing unit, the control information including information indicating input data to be processed and the image processing unit that performs a next process on processed output data; and causing the first image processing unit to execute a first image process on the input data based on the control information and output the output data to the image processing unit that performs a next process.

In order to solve the above problems, a non-transitory computer-readable storage medium storing an image processing control program is provided, the program causing a computer to function as a plurality of image processing units configured to execute an image process for performing printing in a printing apparatus and a control unit configured to cause the plurality of image processing units to execute the image process. The control unit outputs control information to a first image processing unit, the control information including information indicating input data to be processed and the image processing unit that performs a next process on processed output data. The first image processing unit executes a first image process on the input data based on the control information and outputs the output data to the image processing unit that performs a next process.

### BRIEF DESCRIPTION OF THE DRAWINGS

FIG. 1 is a block diagram of an image processing control system.

FIG. 2 is a block diagram of a printing apparatus.

FIG. 3 is a block diagram of a control apparatus.

FIG. 4 is a block diagram of an image processing apparatus.

FIG. 5 is a table illustrating control information.

FIG. 6 is a flowchart of an image process.

FIG. 7 is a flowchart of a communication control process.

FIG. 8 is a diagram illustrating an operation example.

### DESCRIPTION OF EMBODIMENTS

Here, an embodiment of the present disclosure will be described according to the following order.
(1) Configuration of Image Processing Control System
(1-1) Configuration of Printing Apparatus
(1-2) Configuration of Control Apparatus
(1-3) Configuration of Image Processing Apparatus
(2) Control Information
(3) Image Process
(4) Communication Control Process
(5) Examples
(6) Other Embodiments

### (1) Configuration of Image Processing Control System

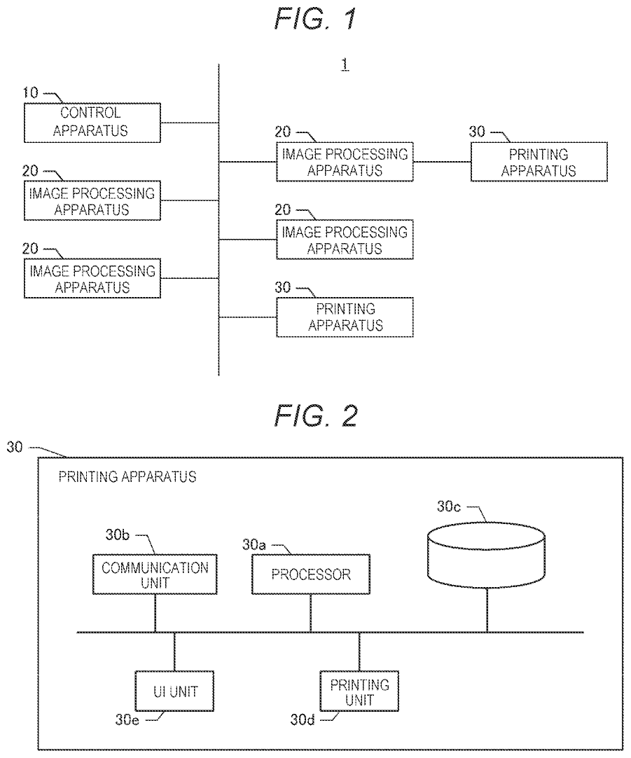

FIG. 1 is a diagram illustrating an example of an image processing control system 1 according to an embodiment of the present disclosure. The image processing control system 1 includes a control apparatus 10, an image processing apparatus 20, and a printing apparatus 30. In the embodiment, the control apparatus 10, the image processing apparatus 20, and the printing apparatus 30 are connected directly or indirectly via a network. In FIG. 1, one control apparatus 10, four image processing apparatuses 20, and two printing apparatuses 30 are shown as an example, and the number of these apparatuses is not limited to the number shown in FIG. 1. The apparatuses are not limited in a connection mode, and may be connected via a local network or via the Internet.

The image processing control system 1 is a system used when executing printing related to a print job using one or more printing apparatuses 30. When executing printing in the printing apparatus 30, image data, for example, portable document format (PDF) data, is specified as an object to be printed. When executing printing, an image process is performed based on the image data. For example, a process of converting an object into raster data based on a printing apparatus description language included in PDF data, a scaling process, a color conversion process, a page layout determination process on a print medium, and a halftone process are executed.

These image processes are generally high-load processes. Accordingly, for example, in a case of performing a plurality of print jobs in parallel by the printing apparatuses 30, the image process may be a bottleneck of an entire printing operation. Therefore, in the embodiment, the plurality of image processing apparatuses 20 can perform distributed image processes. Hereinafter, a configuration of each apparatus provided in the image processing control system 1 will be described.

### (1-1) Configuration of Printing Apparatus

FIG. 2 is a block diagram illustrating a configuration of the printing apparatus 30. The printing apparatus 30 includes a processor 30a, a communication unit 30b, a nonvolatile memory 30c, a printing unit 30d, and a UI unit 30e. The processor 30a includes a CPU, a ROM, a RAM, and the like (not shown), and can execute various programs stored in the nonvolatile memory 30c and control each unit of the printing apparatus 30.

The processor 30a may be implemented by a single chip, may be implemented by a plurality of chips, or may be implemented as an SoC together with various functional blocks. For example, an ASIC may be adopted instead of the CPU, or the CPU and the ASIC may cooperate with each other. When each apparatus in the embodiment includes a processor, the processor can be implemented in various forms similarly to the processor 30a.

The communication unit 30b includes a communication interface for communicating with an external device according to various communication protocols. The printing apparatus 30 can communicate with the image processing apparatus 20 through the communication unit 30b. Naturally, the printing apparatus 30 may be able to communicate with the control apparatus 10. The communication unit 30b may include an interface for communicating with various removable memories mounted on the printing apparatus 30.

The printing unit 30d is a portion for executing printing, and prints contents on a print medium. A printing method is not limited, and various methods such as an ink jet method, a toner method, and a sublimation method can be adopted. The print medium is not limited to print paper and may be various print media such as cloth, ceramic, and resin. The printing unit 30d includes an actuator, various devices, a sensor, a drive circuit, a mechanical component, and the like for executing printing on various print media.

The UI unit 30e includes at least one of a touch panel display, various keys, switches, and LEDs. The touch panel display includes a display panel that displays various types of information such as a status of the printing apparatus 30 and a remaining amount of ink, and a touch detection panel superimposed on the display panel, and detects a touch operation. The LED performs lighting or blinking display indicating a status or the like of the printing apparatus 30. The processor 30a can acquire operation contents of a user via the UI unit 30e. The processor 30a can also display various types of information on a display of the UI unit 30e and notify the user of the information.

In the embodiment, the printing apparatus 30 can perform printing based on print data transmitted from the image processing apparatus 20. That is, the processor 30a acquires the print data from the image processing apparatus 20 via the communication unit 30b and controls the printing unit 30d based on the print data to perform printing.

### (1-2) Configuration of Control Apparatus

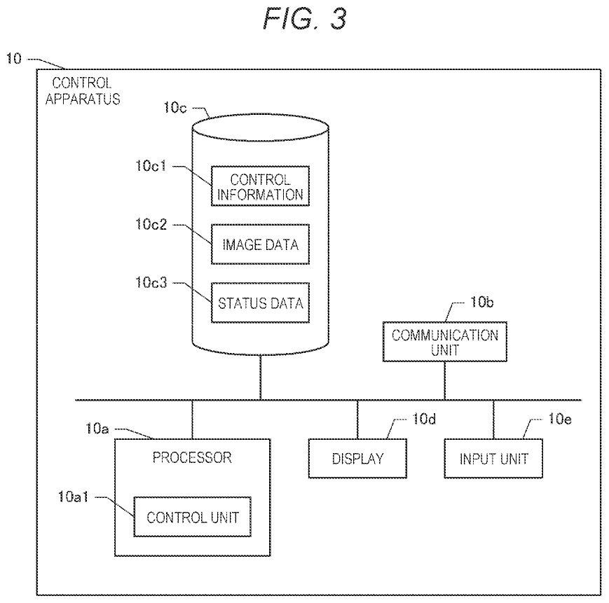

FIG. 3 is a block diagram illustrating a configuration of the control apparatus 10. The control apparatus 10 includes a processor 10a, a communication unit 10b, a nonvolatile memory 10c, a display 10d, and an input unit 10e. The processor 10a includes a CPU, a ROM, a RAM, and the like (not shown), and can execute various programs stored in the nonvolatile memory 10c and control each unit of the control apparatus 10.

The communication unit 10b includes a communication interface for communicating with an external device according to various communication protocols. The control apparatus 10 can communicate with the image processing apparatus 20 via the communication unit 10b. Naturally, the control apparatus 10 may be able to communicate with the printing apparatus 30. The communication unit 10b may include an interface for communicating with various removable memories mounted on the control apparatus 10.

The display 10d is a display device that displays any image. The input unit 10e is a device through which a user performs an input operation, and includes, for example, a keyboard and a mouse. In the embodiment, it is assumed that the control apparatus 10 is a stationary terminal, and naturally, the control apparatus 10 may be a terminal of another form. For example, the control apparatus 10 may be a tablet terminal or a smartphone terminal. In the case of such a terminal, the input unit 10e may be implemented by a touch panel or the like. In any case, the user can input his/her intention by operating the input unit 10e while visually recognizing an image or a character displayed on the display 10d.

Control information 10c1, image data 10c2, and status data 10c3 are stored in the nonvolatile memory 10c of the control apparatus 10. The control information 10c1 is information for specifying the image data 10c2 to be printed, the image processing apparatus 20 that is to execute image processing after start of printing, and a printing apparatus that is to execute printing. Specifically, the information for specifying the image processing apparatus 20 that is to execute the image process is information for specifying an image processing unit that is to execute the image process, and a specific example will be described later. The image data 10c2 is image data indicating print contents, and is, for example, PDF data. In the embodiment, when the control information 10c1 and the image data 10c2 are sequentially transferred as a set to the image processing apparatus 20, the image process is sequentially performed. The image processing apparatus 20 that is to execute the image process can be specified based on the control information 10c1. With this configuration, the control apparatus 10 does not need to manage the image processing apparatus 20 that is an execution subject after the start of printing, and thus a management load on the control apparatus 10 is reduced. The control information 10c1 is information used to reduce such a management load and will be described in detail later.

The status data 10c3 is information indicating progress of the image process. In the embodiment, when each image processing unit provided in the image processing apparatus 20 starts the process and when the processing unit ends the process, information indicating the start and information indicating the end are transmitted to the control apparatus 10. The transmitted information is stored in the nonvolatile memory 10c as the status data 10c3.

The processor 10a executes a control program (not shown). When the processor 10a executes the control program, the processor 10a functions as a control unit 10a1. The control unit 10a1 has a function of causing a plurality of image processing units provided in the image processing apparatus 20 to be described later to execute the image process. In the embodiment, the control information 10c1 including information for specifying the image processing apparatus 20 that is to execute the image process is generated, and the control information 10c1 is transferred to the image processing apparatus 20. Thereafter, the image processing apparatuses 20 are selected sequentially without control performed by the control apparatus 10.

Therefore, the control unit 10a1 performs control to cause the plurality of image processing units provided in the image processing apparatus 20 to execute the image process, and does not perform management of selecting the image processing apparatus 20 each time according to the progress of the image process. That is, the control unit 10a1 generates the control information 10c1 and transfers the control information 10c1 and the image data 10c2, which is an object to be processed, to the image processing apparatus 20 including a first image processing unit that is an initial image processing unit. With this process, it can be said that the control unit 10a1 performs control such that the image processing apparatuses 20 are sequentially selected. After the information is transferred to the first image processing unit, the printing apparatus 30 completes the printing even when the control unit 10a1 does not perform a control process such as selecting the image processing apparatus 20. Therefore, a processing load required for the control unit 10a1 to distribute the image process is extremely small.

The control information 10c1 includes the information for specifying the image processing apparatus 20 that is to execute the image process. Alternatively, the image processing apparatus 20 that is to execute the image process may be determined automatically by the control unit 10a1 or determined by the user. In the case of automatic determination by the control unit 10a1, for example, a configuration may be adopted in which the number of reservations of process is equally distributed to the image processing units provided in the plurality of image processing apparatuses 20. In the case of determination by the user, a configuration may be adopted in which the image processing units of each image processing apparatus 20 are displayed on the display 10d, and a specification of the user is received through the input unit 10e. In any case, for each print job, which image processing unit of which image processing apparatus 20 executes image process necessary for printing is determined in advance, and described in the control information 10c1 by the control unit 10a1.

The control unit 10a1 in the embodiment can execute the process according to the status data. When the status data 10c3 is stored in the nonvolatile memory 10c, the control unit 10a1 can execute the process according to the status data 10c3. The process according to the status data 10c3 may be various types of processes, such as displaying a status. Specifically, the control unit 10a1 refers to the status data 10c3 and displays, on the display 10d, a progress status of the image process indicated by the status data 10c3. According to this configuration, the user can grasp the progress of the image process related to the print job. The process according to the status data 10c3 is not limited to display, and a warning according to the status may be issued, or progress management such as standby or restart of image process may be performed according to the status.

### (1-3) Configuration of Image Processing Apparatus

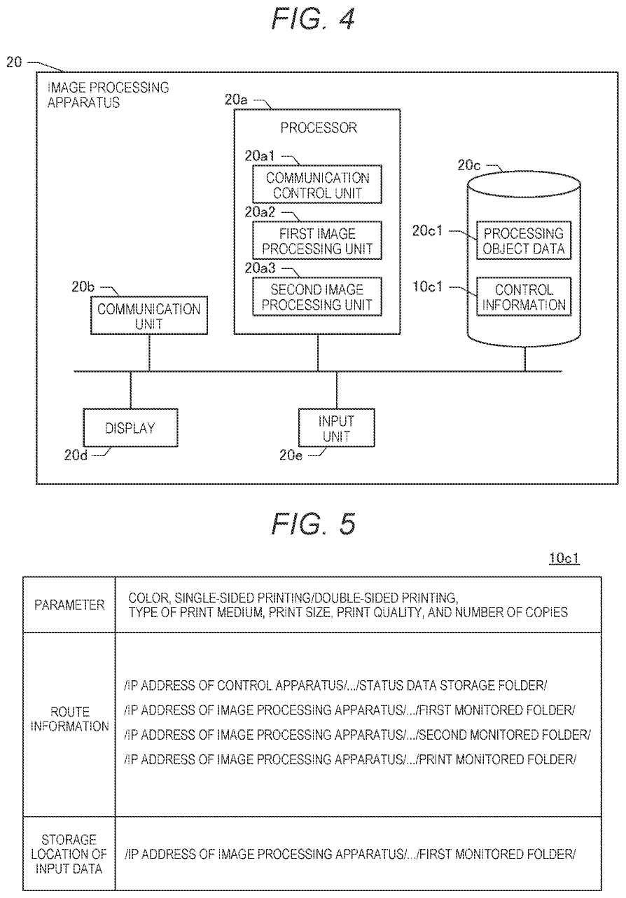

FIG. 4 is a block diagram illustrating a configuration of the image processing apparatus 20. The image processing apparatus 20 includes a processor 20a, a communication unit 20b, a nonvolatile memory 20c, a display 20d, and an input unit 20e. The processor 20a includes a CPU, ROM, RAM, and the like (not shown), and can execute various programs stored in the nonvolatile memory 20c and control each unit of the image processing apparatus 20. The processor 20a can also execute various types of arithmetic processes such as an image process.

The communication unit 20b includes a communication interface for communicating with an external device according to various communication protocols. The image processing apparatus 20 can communicate with the control apparatus 10 and the printing apparatus 30 via the communication unit 20b. The communication unit 20b may include an interface for communicating with various removable memories mounted on the image processing apparatus 20.

The display 20d is a display device that displays any image. The input unit 20e is a device through which a user performs an input operation, and includes, for example, a keyboard and a mouse. In the embodiment, it is assumed that the image processing apparatus 20 is a stationary terminal, and naturally, the image processing apparatus 20 may be a terminal of another form. For example, the control apparatus 10 may be a tablet terminal or a smartphone terminal. In the case of such a terminal, the input unit 20e may be implemented by a touch panel or the like. In any case, the user can input his/her intention by operating the input unit 20e while visually recognizing an image or a character displayed on the display 20d. In the nonvolatile memory 20c, the control information 10c1 and processing object data 20c1, which is data during the process performed by the image processing unit, are stored.

The processor 20a executes a print control program (not shown). When the processor 20a executes the print control program, the processor 20a functions as a communication control unit 20a1, a first image processing unit 20a2, and a second image processing unit 20a3. Note that the processor 20a of the image processing apparatus 20 shown in FIG. 4 can execute the first image processing unit 20a2 and the second image processing unit 20a3, but the processor 20a may be configured to execute one of these image processing units. When it is not necessary to distinguish between the first image processing unit 20a2 and the second image processing unit 20a3, the first image processing unit 20a2 and the second image processing unit 20a3 may be simply referred to as the image processing unit.

In the embodiment, each of the communication control unit 20a1, the first image processing unit 20a2, and the second image processing unit 20a3 monitors a predetermined storage location. When the control information 10c1 is newly stored at the storage location, the corresponding unit performs the process according to the stored control information 10c1. Specifically, the information stored in the nonvolatile memory 20c is stored in a folder that is a logical storage location having a hierarchical structure.

In the embodiment, a print monitored folder as a folder monitored by the communication control unit 20a1, a first monitored folder as a folder monitored by the first image processing unit 20a2, and a second monitored folder as a folder monitored by the second image processing unit 20a3 are set in advance. That is, each folder is associated with a corresponding processing unit. Each folder can be specified by a path. That is, it is possible to specify each folder by a path that starts with identification information (an IP address in the embodiment) of the image processing apparatus 20 and describes folder names in order from upper hierarchies to the target folder. The image processing control system 1 according to the embodiment may include a plurality of image processing apparatuses 20, and different image processing apparatuses 20 have different identification information included in the path. Accordingly, monitored objects of the first image processing units 20a2 and the second image processing units 20a3 provided in the different image processing apparatuses 20 are different folders, and the folders are distinguished by different paths.

The communication control unit 20a1 has a function of controlling communication between the image processing apparatus 20 and the control apparatus 10 and communication between the image processing apparatus 20 and the printing apparatus 30. In the embodiment, when the control information 10c1 is stored in the print monitored folder, the communication control unit 20a1 starts the process based on the control information 10c1. In the embodiment, since the print data is stored in the print monitored folder together with the control information 10c1, the communication control unit 20a1 transmits the print data to the printing apparatus 30 to execute printing. In the embodiment, the print monitored folder is associated with the printing apparatus 30. Accordingly, when the print data is stored in the print monitored folder, the printing apparatus 30 associated with the print monitored folder is specified as a printing subject. Naturally, a method for specifying the printing apparatus 30 may be various. For example, identification information of the printing apparatus 30 may be described in the control information 10c1.

Each of the first image processing unit 20a2 and the second image processing unit 20a3 has a function of executing a part of the image process for printing in the printing apparatus 30. In the embodiment, the first image processing unit 20a2 executes an initial image process among a series of processes of converting the image data 10c2 into the print data that can be processed by the printing apparatus 30. The second image processing unit 20a3 performs an image process to be performed next to the image process performed by the first image processing unit 20a2.

Output data processed by the second image processing unit 20a3 is the print data that can be processed by the printing apparatus 30. Accordingly, when the first image processing unit 20a2 processes the image data and the second image processing unit 20a3 processes the processed data, the print data that can be processed by the printing apparatus 30 is generated.

As long as the first image processing unit 20a2 and the second image processing unit 20a3 are image processing units that execute the series of image processes, each of the first image processing unit 20a2 and the second image processing unit 20a3 may handle any part of the series of image processes. In the embodiment, the first image processing unit 20a2 handles processes up to rasterization, for example, analysis based on the printing apparatus description language included in the image data 10c2 and a conversion process to raster data. The second image processing unit 20a3 handles processes after the rasterization, for example, a color conversion process based on the raster data, a page layout determination process on a print medium, and a halftone process.

The first image processing unit 20a2 and the second image processing unit 20a3 execute the image process, and for each processing unit, data input and data output are different. In the present specification, data to be processed by each processing unit may be referred to as input data and data generated by the process may be referred to as output data. The input data and the output data are the processing object data 20c1 shown in FIG. 4.

In the embodiment, when the control information 10c1 is stored in the first monitored folder, the first image processing unit 20a2 starts the process based on the control information 10c1. In the embodiment, in the first monitored folder, the image data that is input data to be processed is stored together with the control information 10c1. The first image processing unit 20a2 generates the raster data that is output data based on the input data, and stores the output data in the second monitored folder indicated by the control information 10c1. Since the storage into the second monitored folder functions as a processing start request to the second image processing unit 20a3, it can be said that the first image processing unit 20a2 outputs the output data to the second image processing unit 20a3 that performs the next process.

In the embodiment, when the control information 10c1 is stored in the second monitored folder, the second image processing unit 20a3 starts the process based on the control information 10c1. In the embodiment, in the second monitored folder, the raster data that is input data to be processed is stored together with the control information 10c1. The second image processing unit 20a3 generates the print data that is output data based on the input data, and stores the output data in the print monitored folder indicated by the control information 10c1. The storage into the print monitored folder is a processing start request to the communication control unit 20a1.

Although FIG. 4 illustrates a configuration of one image processing apparatus 20, the image processing control system 1 includes a plurality of image processing apparatuses 20 as illustrated in FIG. 1. In the embodiment, the image data is converted into the print data by using any of a plurality of the first image processing units 20a2 and the second image processing units 20a3 that exist in a distributed manner in the plurality of image processing apparatuses 20. The first image processing unit 20a2 and the second image processing unit 20a3 that execute the image process may be provided in different image processing apparatuses 20, and an image processing unit that is to perform the process is specified by the control information 10c1. Accordingly, when the control information 10c1 is generated in the control apparatus 10 and the control information 10c1 is stored in the first monitored folder to start the image process performed by the first image processing unit 20a2, it is not necessary for the control apparatus 10 to perform a process related to distribution of the image processing units thereafter. Accordingly, in the control apparatus 10, it is not necessary to perform a process of determining a distribution destination of the image process, a process of allocating data before and after the image process, or the like, and thus the processing load is reduced as compared with a case where these processes are performed. Hereinafter, a configuration for implementing such reduction in the processing load will be described in detail.

### (2) Control Information

FIG. 5 is a table illustrating an example of the control information 10c1. In the embodiment, the control information 10c1 includes a parameter used in the image process, route information, and a storage location of input data. In the embodiment, the parameter used in the image process is a value indicating a print setting. In FIG. 5, a color, single-sided printing/double-sided printing, a type of print medium, a print size, a print quality, and the number of copies are shown as examples of print setting items. Since contents of the image process may vary due to setting values of these items, the control information 10c1 includes the parameter. For example, when a color setting is black and white, the raster data generated by the first image processing unit 20a2 is generated in grayscale. For example, the first image processing unit 20a2 specifies a resolution according to the print size and the print quality, and generates the raster data according to the resolution.

The route information is information indicating a route along which data transitions from the start of printing based on the image data to the generation of the print data. In the embodiment, the route information includes information specifying an image processing unit that is to perform a series of processes for printing of the printing apparatus among the plurality of image processing units. Specifically, the route information includes a path of a monitored folder monitored by the image processing unit that is to perform the process. Since the monitored folder is associated with the image processing unit, specifying the monitored folder by the path is equivalent to specifying the image processing unit that is to perform the process.

In the embodiment, a storage location where the status data 10c3 is stored in the nonvolatile memory 10c of the control apparatus 10 is a specific folder determined in advance. Here, this folder is referred to as a status data storage folder. In the embodiment, each image processing unit generates the status data 10c3 indicating progress in the process, and stores the status data 10c3 in the status data storage folder. As a result, the status data 10c3 indicating the progress of the series of processes for printing is sequentially stored in the status data storage folder in the nonvolatile memory 10c of the control apparatus 10. Therefore, it is possible to specify the progress of the image process in the control apparatus 10.

The route information in the control information 10c1 includes paths of the status data storage folder, the monitored folders monitored by the image processing units, and the monitored folder monitored by the communication control unit 20a1. A description mode of the paths may be various, and in the embodiment, the route information is formed such that the path of the status data storage folder is the first one and following paths are described in order of progress of the image process.

For example, in the example shown in FIG. 5, the path of the status data storage folder is described first (at the top) in the route information. That is, the path of the status data storage folder, which starts with an IP address of the control apparatus 10 and ends with a name of the status data storage folder, is disposed first in the route information.

Next to the path of the status data storage folder, the path of the monitored folder monitored by the first image processing unit 20a2 that performs a first image process is described. That is, the path of the first monitored folder, which starts with an IP address of the image processing apparatus 20 and ends with a name of the first monitored folder, is disposed. Next, the path of the second monitored folder is disposed, and finally, the path of the print monitored folder is disposed, whereby the route information is formed.

The storage location of the input data is specified by a path of a folder where the input data to be processed by the first image processing unit 20a2 or the second image processing unit 20a3 is stored. In the embodiment, the monitored folders associated with the respective image processing units are the storage locations of the input data. Accordingly, in the embodiment, the storage location of the control information 10c1 coincides with the storage location of the input data, and the input data and the control information 10c1 are stored as a set in the monitored folder. Accordingly, the control information 10c1 may be considered as including the input data. Other types of data necessary for the image process, for example, an ICC profile may be stored at the storage location of the input data.

In the example illustrated in FIG. 5, the storage location of the input data is indicated by the path of the first monitored folder. Accordingly, the control information 10c1 illustrated in FIG. 5 is information transferred to the first image processing unit 20a2, and when the control information 10c1 is transferred to the second image processing unit 20a3, the storage location of the input data is rewritten. That is, when the first image processing unit 20a2 performs the image process based on the control information 10c1 illustrated in FIG. 5 and then outputs the output data to the second image processing unit 20a3 that performs the next process, the storage location of the input data is rewritten to the path of the second monitored folder.

It can be said that the control information 10c1 as described above includes information indicating the input data to be processed. Specifically, the image processing unit can acquire the input data to be processed, by referring to the storage location of the input data indicated by the control information 10c1. Accordingly, the storage location of the input data is information indicating the input data to be processed. In the example illustrated in FIG. 5, the storage location of the input data coincides with the storage location of the control information 10c1, that is, the monitored folder. Alternatively, the storage location of the input data may be different from the storage location of the control information 10c1.

Further, it can be said that the control information 10c1 includes information indicating the image processing unit that is to perform a next process on the processed output data. Specifically, in the route information, the paths of the folders monitored by the image processing units are described according to the order of the image process. Accordingly, an image processing unit that performs a certain image process can specify that a monitored folder described next to the monitored folder associated with the image processing unit is a folder monitored by an image processing unit that is to perform a next image process. For example, in the example illustrated in FIG. 5, when the first image processing unit 20a2 performs the image process, it can be specified that the second image processing unit 20a3 associated with the second monitored folder described next to the first monitored folder monitored by the first image processing unit 20a2 is to perform a next process.

### (3) Image Process

Next, the image process executed by the image processing unit based on the control information 10c1 described above will be described. The control information 10c1 is generated in the control apparatus 10. In the control apparatus 10, an application program (not shown) can be executed, and the user can use the display 10d and the input unit 10e as user interfaces and instruct printing of any piece of image data. At this time, the user operates the input unit 10e to input the print setting.

When printing is instructed, the control information 10c1 is generated by the function of the control unit 10a1. The control information 10c1 may be automatically generated by the control unit 10a1 or may be generated by the user. Here, the case of generation by the user is assumed. In this case, the user operates the input unit 10e to specify the image processing apparatus 20 and the image processing unit that are to execute the image process from options of the image processing units displayed on the display 10d, and the printing apparatus 30. Then, the control unit 10a1 generates the control information 10c1 for performing the image process in the specified image processing unit and performing printing in the specified printing apparatus 30.

When the control information 10c1 is generated, the control unit 10a1 stores the control information 10c1 and the input data in the monitored folder of the first image processing unit 20a2 indicated in the control information 10c1. Thereafter, the image processing unit performs the image process in an order indicated in the control information 10c1.

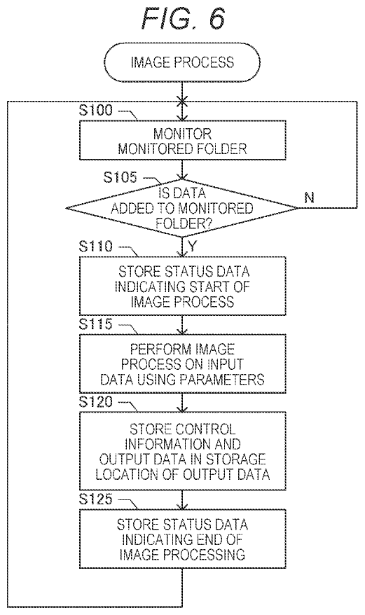

FIG. 6 is a flowchart of the image process. The image process is a process executed by each of the first image processing unit 20a2 and the second image processing unit 20a3. Although differences may occur in the parameter, the input data, and the output data in this process, a flow of the process is common to the image processing units, and thus the flow of the process will be described herein without distinguishing the differences between the image processing units.

The first image processing unit 20a2 and the second image processing unit 20a3 installed in the image processing apparatus 20 each execute the image process shown in FIG. 6. In the image process, the image processing unit monitors the monitored folder (step S100) and determines whether data is added to the monitored folder (step S105). That is, the image processing unit periodically refers to the monitored folder associated in advance with the image processing unit and determines whether new data is added. When it is not determined that new data is added, the image processing unit executes step S100 and subsequent steps.

When it is determined in step S105 that new data is added to the monitored folder, the control information 10c1 and the input data are stored as a set in the monitored folder. Therefore, the image processing unit stores status data indicating a start of the image process (step S110). That is, the image processing unit refers to the control information 10c1 to specify a path of a status data storage folder, outputs the status data 10c3 indicating the start of the image process to the control apparatus 10, and stores the status data 10c3 in the status data storage folder.

Next, the image processing unit performs the image process on the input data using parameters (step S115). That is, the image processing unit refers to the control information 10c1 to acquire the input data stored at a storage location of the input data, and specifies the parameters of the image process based on the control information 10c1. Then, the image processing unit performs the image process, in which the parameters are applied, on the input data, and generates output data.

Next, the image processing unit stores the control information 10c1 and the output data at a storage location of the output data (step S120). That is, the image processing unit refers to the control information 10c1 to specify a monitored folder monitored by the image processing unit that is to perform a next process, and stores the control information 10c1 and the output data in the monitored folder.

Next, the image processing unit stores the status data indicating an end of the image process (step S125). That is, the image processing unit refers to the control information 10c1 to specify the path of the status data storage folder, outputs the status data 10c3 indicating the end of the image process to the control apparatus 10, and stores the status data 10c3 in the status data storage folder. According to the above configuration, the image process can be sequentially executed in the order indicated in the control information 10c1.

### (4) Communication Control Process

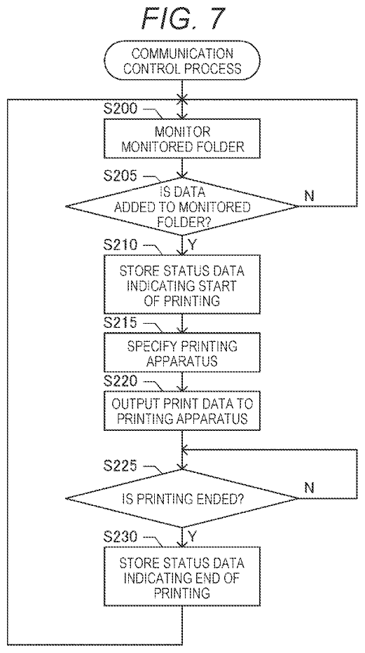

Next, a communication control process executed by the communication control unit 20a1 based on the control information 10c1 will be described. FIG. 7 is a flowchart of the communication control process. The communication control process is a process executed by the communication control unit 20a1. The communication control unit 20a1 installed in each image processing apparatus 20 executes the communication control process illustrated in FIG. 7. In the communication control process, the communication control unit 20a1 monitors the print monitored folder (step S200), and determines whether data is added to the print monitored folder (step S205). That is, the communication control unit 20a1 periodically refers to the print monitored folder associated in advance with the communication control unit 20a1 and determines whether new data is added. When it is not determined that new data is added to the print monitored folder, the communication control unit 20a1 executes step S200 and subsequent steps.

When it is determined in step S205 that new data is added to the print monitored folder, the control information 10c1 and the input data are stored as a set in the print monitored folder. The communication control unit 20a1 stores the status data indicating the start of printing (step S210). That is, the communication control unit 20a1 refers to the control information 10c1 to specify the path of the status data storage folder, outputs the status data 10c3 indicating the start of printing to the control apparatus 10, and stores the status data 10c3 in the status data storage folder.

Next, the communication control unit 20a1 specifies the printing apparatus (step S215). That is, the communication control unit 20a1 refers to the control information 10c1 to specify the print monitored folder, and specifies the printing apparatus corresponding to the print monitored folder. Next, the communication control unit 20a1 outputs the print data to the printing apparatus 30 (step S220). That is, the output data stored in the print monitored folder is the print data to be output to the printing apparatus 30 specified in step S215. Therefore, the communication control unit 20a1 outputs the print data to the printing apparatus 30. As a result, the printing apparatus 30 as an output destination executes printing based on the print data.

When the printing is ended in the printing apparatus 30, the printing apparatus 30 notifies the communication control unit 20a1, which is an output source of the print data, of the end of printing. The communication control unit 20a1 determines whether the printing is ended based on the notification (step S225), and repeats the determination of step S225 until it is determined that the printing is ended.

When it is determined in step S225 that the printing is ended, the communication control unit 20a1 stores the status data indicating the end of printing (step S230). More specifically, the communication control unit 20a1 refers to the control information 10c1 to specify the path of the status data storage folder, outputs the status data 10c3 indicating the end of printing to the control apparatus 10, and stores the status data 10c3 in the status data storage folder. According to the above configuration, it is possible to execute printing based on the print data that is generated by performing the image process according to the order indicated in the control information 10c1.

### (5) Examples

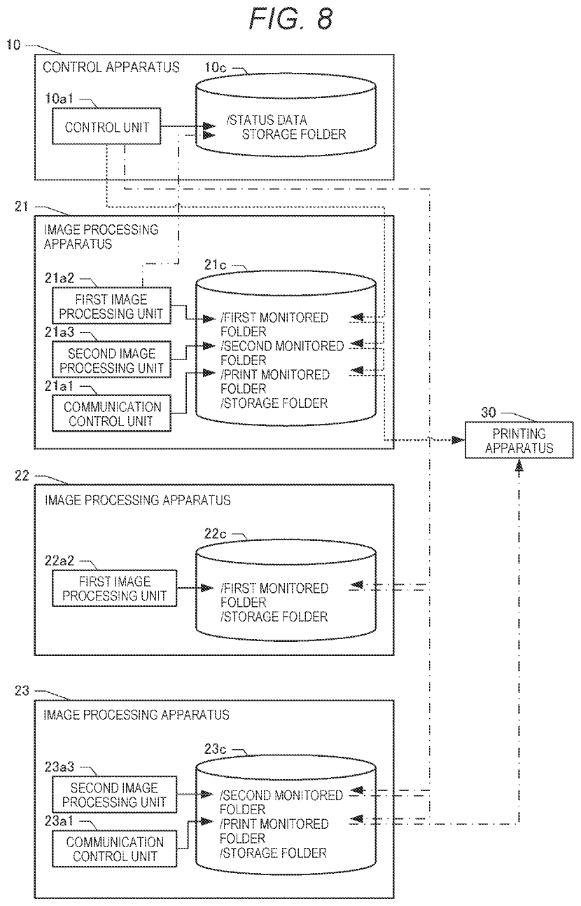

Next, a flow of the image process according to the above-described configuration will be described as an example. FIG. 8 is a diagram illustrating a configuration example of the image processing control system 1. FIG. 8 illustrates an example in which one control apparatus 10, one printing apparatus 30, and three image processing apparatuses 20 are provided. To distinguish the three apparatuses from each other, the image processing apparatuses 20 are denoted as image processing apparatuses 21, 22, and 23. In FIG. 8, a part of configurations of the control apparatus 10 and the image processing apparatuses 21, 22, and 23 are extracted and shown.

In the example illustrated in FIG. 8, the image processing apparatus 21 includes a first image processing unit 21a2 and a second image processing unit 21a3. The image processing apparatus 22 includes a first image processing unit 22a2 and does not include any second image processing unit. The image processing apparatus 23 includes a second image processing unit 23a3 and does not include any first image processing unit. The image processing apparatuses 21 and 23 include a communication control unit 21a1 and a communication control unit 23a1, respectively. Since the image processing apparatus 22 does not include any second image processing unit that generates print data to be output to the printing apparatus 30, no communication control unit is shown therein. Naturally, the image processing apparatus 22 may include a communication control unit that controls communication between the control apparatus 10 and the image processing apparatus 22.

In the example illustrated in FIG. 8, the control apparatus 10 and the image processing apparatuses 21, 22, and 23 include nonvolatile memories 10c, 21c, 22c, and 23c, respectively. Data stored in each nonvolatile memory is stored in association with a folder prepared in advance. In FIG. 8, folders set in nonvolatile memories 10c, 21c, 22c, and 23c are shown, and folders as monitored objects of the respective units are indicated by arrows of solid lines extending from the control unit 10a1, the image processing units, and the communication control units to the folders. FIG. 8 illustrates an example in which output data subjected to the image processes performed by the image processing apparatuses 21, 22, and 23 can be stored without being transferred to a next process, and folders for storing the output data are illustrated as storage folders.

In the above configuration, the image process for converting the image data into the print data is executed by any of the image processing units provided in the image processing apparatuses 21, 22, and 23. That is, the image data is processed by any of the first image processing units 21a2 and 22a2, and the output data of the process is processed by any of the second image processing units 21a3 and 23a3. In this way, the image processing unit that performs the process can be selected as desired from the plurality of image processing units, and thus a processing load of the image process can be distributed.

The distribution of the process can be implemented by description of the folder paths in the control information 10c1. For example, a case is assumed where the image process is performed by the first image processing unit 21a2 and the second image processing unit 21a3 of the image processing apparatus 21 and printing is performed by the printing apparatus 30, as indicated by arrows of a broken line. In this case, the control information 10c1 describes the path of the first monitored folder, the path of the second monitored folder, and the path of the print monitored folder set in the image processing apparatus 21.

When the control information 10c1 is stored in the first monitored folder of the image processing apparatus 21 together with the image data, the first image processing unit 21a2 performs the image process using the image data as the input data, and stores the control information 10c1 and the output data in the second monitored folder of the image processing apparatus 21. When the control information 10c1 and the output data are stored in the second monitored folder of the image processing apparatus 21, the second image processing unit 21a3 performs the image process using the stored data as the input data, and stores the control information 10c1 and the output data in the print monitored folder of the image processing apparatus 21. When the control information 10c1 and the output data are stored in the print monitored folder of the image processing apparatus 21, the communication control unit 21a1 outputs the print data, which is the stored data, to the printing apparatus 30. As a result, printing is executed in the printing apparatus 30. An arrow of a two-dot chain line indicates a flow of the status data 10c3. FIG. 8 illustrates an example of the flow when the status data 10c3 is transmitted from the first image processing unit 21a2 to the status data storage folder of the control apparatus 10. Naturally, the status data 10c3 indicating progress in the other image processing units is sequentially stored in the status data storage folder.

Meanwhile, a case is assumed where the image process is performed by the first image processing unit 22a2 of the image processing apparatus 22 and the second image processing unit 23a3 of the image processing apparatus 23 and printing is performed by the printing apparatus 30, as indicated by arrows of a one-dot chain line. In this case, the control information 10c1 describes the path of the first monitored folder set in the image processing apparatus 22, and the path of the second monitored folder and the path of the print monitored folder set in the image processing apparatus 23.

When the control information 10c1 is stored in the first monitored folder of the image processing apparatus 22 together with the image data, the first image processing unit 22a2 performs the image process using the image data as the input data, and stores the control information 10c1 and the output data in the second monitored folder of the image processing apparatus 23. When the control information 10c1 and the output data are stored in the second monitored folder of the image processing apparatus 23, the second image processing unit 23a3 performs the image process using the stored data as the input data, and stores the control information 10c1 and the output data in the print monitored folder of the image processing apparatus 23. When the control information 10c1 and the output data are stored in the print monitored folder of the image processing apparatus 23, the communication control unit 23a1 outputs the print data, which is the stored data, to the printing apparatus 30. As a result, printing is executed in the printing apparatus 30.

As described above, in the embodiment, the image processing unit that is a distribution destination is described in the control information 10c1 in advance, and the image process proceeds according to the control information 10c1. Therefore, it is not necessary for the control apparatus 10 to perform management such as determining the image processing apparatus 20, which serves as an execution subject, after the image process is started, and the processing load is reduced as compared with a case where the control apparatus 10 performs the management. As described, by distributing the processes of a large number of jobs to a plurality of image processing apparatuses and performing the processes in parallel while reducing the processing load of the control apparatus 10, a processing waiting time can be significantly reduced as compared with a case where one apparatus processes the large number of jobs. Further, in the embodiment, it is determined in advance that the process to be performed by the second image processing unit is performed after the image process performed by the first image processing unit. Therefore, the image process for converting the image data into the print data is subdivided, and a degree of freedom in selecting the distribution destination is increased as compared with a case where the image process is not subdivided. It is sufficient that the distribution destination of the image processing is selected one by one from the first image processing unit and the second image processing unit, and the distribution destination can be easily selected.

Further, in the embodiment, the image processing unit monitors the monitored folder, and the process is started in response to update of data in the monitored folder. Accordingly, simply by a process of storing data in a predetermined folder, the input data and the output data necessary for the series of image processes can be transferred. Therefore, distribution destinations of the series of image processes can be defined by a simple process of describing paths in the control information.

Further, in the embodiment, by monitoring the print monitored folder, the communication control unit detects that the print data is generated after the image process and outputs the print data to the printing apparatus. Accordingly, data related to printing can be transferred simply by a process of storing the data in the predetermined folder. Therefore, the printing apparatus that is the printing subject can be defined by a simple process of describing the path in the control information.

Further, in the embodiment, the status data indicating the progress of the image process is stored at the predetermined storage location. Accordingly, by referring to the status data at the storage location, it is possible to easily specify the progress of the image process that is performed in a distributed manner. Further, in the embodiment, before starting the image process, the paths of the folders monitored by the image processing units that are to perform the series of processes are described in the control information. Therefore, the image processing unit can be easily specified. The processing load on the control apparatus can also be reduced.

Further, in the embodiment, since the control information and the input data are stored as a set in a common folder, it is not necessary to extract data used for the image process from a plurality of storage destinations, and thus a process performed by the image processing unit can be simplified. Further, in the embodiment, since the control information includes parameters used in the image process, it is not necessary to extract the parameters used in the image process from a storage location different from that of the control information, and thus the process performed by the image processing unit can be simplified.

### (6) Other Embodiments

The above-described embodiment is an example for implementing the disclosure, and various other embodiments may be adopted. For example, an apparatus configuration of the image processing control system is not limited to the configuration illustrated in FIG. 1. The control apparatus 10 and the image processing apparatus 20 may have a common configuration. Specifically, the control unit 10a1, the first image processing unit 20a2, and the second image processing unit 20a3 may be installed in computers, and each computer may function as any of the control apparatus 10 and the image processing apparatus 20. In this case, each computer includes the first image processing unit 20a2 and the second image processing unit 20a3, and a specific computer may be set to function as one of the first image processing unit 20a2 and the second image processing unit 20a3. In this case, the specific computer is set not to function as the other image processing unit.

The apparatuses shown in FIG. 1 may be a smaller number of terminals sharing functions or may be a larger number of terminals. For example, the image processing apparatus 20 and the printing apparatus 30 may be an integrated apparatus, and the control apparatus 10 and the image processing apparatus 20 may be implemented by a cloud computer.

It is sufficient that the image processing control system is a system including a plurality of image processing units that execute an image process for performing printing in a printing apparatus, and a control unit that causes the plurality of image processing units to execute the image process. Accordingly, another apparatus, for example, a printing apparatus, may be provided. The number of image processing units is not limited, and a plurality of control units and printing apparatuses may be provided.

It is sufficient that the image processing unit is capable of executing the image process for printing in the printing apparatus. At least two types of image processes are sequentially executed during a period from when a print instruction is issued to when printing is started, and there are two types of image processing units that perform the respective types of image processes. Three or more types of image processes may be sequentially executed during the period from when the print instruction is issued to when the printing is started, and in this case, information is also transmitted to third and subsequent image processing units based on control information.

Although a plurality of computers function as the image processing units in the above-described embodiment, it is sufficient that one computer is capable of implementing one or more types of image processing units, and one computer may be capable of implementing two or more types of image processing units. One type of image processing unit may be implemented in one computer, and two or more computers that are capable of implementing any type of image processing unit may co-exist.

The image processing units are distinguished from each other as the first image processing unit performing a rasterization process and the like and the second image processing unit performing a halftone process and the like, and are not limited thereto. For example, there may be another image processing unit that performs a layout process and a halftone process.

Although it is sufficient that the control unit is capable of causing the plurality of image processing units to execute the image process, the control is executed based on the control information. Accordingly, it is not necessary for the control unit to control a distribution destination of the image process after outputting the control information to the first image processing unit.

It is sufficient that the control information includes information indicating input data to be processed and the image processing unit that performs a next process on processed output data. That is, it is sufficient that the control information includes information to be referred to at the time of inputting to and outputting from the image processing unit, and the image process sequentially proceeds with reference to the control information.

It is sufficient that the information, which is included in the control information and indicates the input data to be processed, is defined such that the image processing unit can acquire the input data based on the information and start the image process. Accordingly, the information indicating the input data to be processed may be the input data itself as in the above-described embodiment, or may be information indicating a storage location where the input data is stored.

It is sufficient that the information, which is included in the control information and indicates the image processing unit that performs a next process on the processed output data, is defined such that the image processing unit to which the output data is to be input can be specified based on the information. Accordingly, the configuration is not limited to the configuration in which the image processing unit to which the output data is to be input is specified by indicating the storage location associated with the image processing unit as in the above-described embodiment. For example, a configuration in which the image processing unit is specified by an ID of a computer where the image processing unit is installed or an ID associated with the image processing unit may be adopted. The input data and the output data may be data of any form, and a format thereof can be changed through the image process performed by the image processing unit.

The present disclosure is also applicable to a program and a method executed by a computer. The system, the program, and the method as described above may be implemented as a single apparatus, may be implemented using components provided in a plurality of apparatuses, each element may be provided in an apparatus different from the above-described apparatus, and various modes may be provided. Further, the present disclosure may be modified appropriately, and for example, a part is designed to be software and a part is designed to be hardware. Furthermore, the present disclosure is also established as a storage medium of a program that controls the system. Naturally, the storage medium of the program may be a magnetic storage medium or a semiconductor memory, and any storage medium to be developed in the future can be considered in exactly the same way.

What is claimed is:

1. An image processing control system including a plurality of image processing units configured to execute an image process for performing printing in a printing apparatus and a control unit configured to cause the plurality of image processing units to execute the image process, wherein
the control unit outputs control information to a first image processing unit, the control information including information indicating input data to be processed and the image processing unit that performs a next process on processed output data, and
the first image processing unit executes a first image process on the input data based on the control information and outputs the output data to the image processing unit that performs a next process.

2. The image processing control system according to claim 1, wherein
the plurality of image processing units include the first image processing unit and a second image processing unit that executes the image process to be executed after the image process executed by the first image processing unit, and at least the second image processing unit can be implemented in a plurality of computers,
the control information includes information indicating the second image processing unit that performs a next process on the output data after the process by the first image processing unit, and
the first image processing unit outputs the output data to the second image processing unit indicated by the control information after the first image process.

3. The image processing control system according to claim 1, wherein
a storage location where the control information is stored is associated with each of the plurality of image processing units, and
the image processing unit monitors the storage location associated with the image processing unit, and when the control information is stored at the storage location, starts the image process based on the input data indicated by the stored control information, and stores the control information at the storage location associated with the image processing unit that performs a next process.

4. The image processing control system according to claim 3, wherein
the control information includes information indicating the printing apparatus that executes printing, and
the storage location includes a location associated with the image processing unit that generates the output data to be output to the printing apparatus, and when the control information is stored at the location, the output data is output to the printing apparatus indicated by the stored control information and printing is performed.

5. The image processing control system according to claim 1, wherein
the control information includes information indicating a storage location of status data indicating progress of the image process,
the image processing unit stores the status data at the storage location, and
the control unit executes a process according to the status data stored at the storage location.

6. The image processing control system according to claim 1, wherein
the control information includes information specifying the image processing unit that performs a series of processes for printing of the printing apparatus among the plurality of image processing units, and
the specified image processing unit executes the image process.

7. The image processing control system according to claim 1, wherein
the control information includes the input data.

8. The image processing control system according to claim 1, wherein
the control information includes a parameter used in the image process, and
the image processing unit executes the image process using the parameter.

9. A control apparatus for causing a plurality of image processing units, which are configured to execute an image process for performing printing in a printing apparatus, to execute the image process, wherein
the control apparatus outputs control information to the image processing unit, the control information including information indicating input data to be processed and the image processing unit that performs a next process on processed output data.

10. An image processing apparatus for executing any of a plurality of image processes for performing printing in a printing apparatus, wherein
the image processing apparatus executes the image process on input data to be processed, based on control information including information indicating the input data and an image processing apparatus that executes a next process on processed output data, and outputs the output data to the image processing apparatus that executes a next process.
